(19) United States
(12) Patent Application Publication
(10) Pub. No.: US 2026/0313259 A1
(43) Pub. Date: Oct. 8, 2026

(54) CIS DR IMAGE SENSOR WITH LINEAR OUTPUT COMPRESSED PROCESSING AND AF HANDLING

(71) Applicant: SAMSUNG ELECTRONICS CO., LTD., Suwon-si (KR)

(72) Inventors: Shahaf DUENYAS, Tel-Aviv (IL); Gal BITAN, Tel-Aviv (IL); Shira SARDI, Tel-Aviv (IL); Doron SABO, Tel-Aviv (IL); Roee SFARADI, Tel-Aviv (IL)

(73) Assignee: SAMSUNG ELECTRONICS CO., LTD., Suwon-si (KR)

(21) Appl. No.: 19/169,714

(22) Filed: Apr. 3, 2025

(51) Int. Cl. H04N 25/58; H04N 23/67; H04N 23/741; H04N 23/76; H04N 25/616

(52) U.S. Cl. CPC H04N 25/58; H04N 23/672; H04N 23/741; H04N 23/76; H04N 25/616

(57) ABSTRACT

A method for performing dynamic range (DR) image processing, including: obtaining a plurality of first images using an image sensor; merging the plurality of first images to obtain a second image, wherein a dynamic range of the second image is higher than a dynamic range of each of the plurality of first images; compressing the second image using a compression function to obtain a compressed second image; performing image processing on the compressed second image to obtain a processed image; and obtaining an output image by decompressing the processed image using a transposition of the compression function, wherein the compression function is divided into a plurality of segments, and wherein a compression power for each segment of the plurality of segments is determined based on a noise profile of the image sensor.

### BACKGROUND

The disclosure relates to computer vision and image processing, and more particularly to performing dynamic range (DR) image processing.

Dynamic range (DR) is an important feature of imagers and image sensors, for example, complementary metal-oxide-semiconductor (CMOS) imagers and image sensors. The DR of an image may refer to a range of luminosity between the brightest area and the darkest area of an image. A high DR (HDR) image may refer to an image which includes a large amount of variation in luminosity levels.

There are many different techniques for obtaining HDR images, many of which may present challenges. For example, a relatively large number of bits may be used to express the full DR of the HDR image, and this increased bittage may result in increased processing and memory requirements for the on-sensor processing and output. In addition, HDR images may increase the amount of autofocus (AF) data which may be captured and processed in order to increase detail in low light or saturated areas for improved auto-focus procedure. However, although many popular standard image formats result in a compressed image, the output of an image sensor is usually expressed in the full bittage in a linear manner.

### SUMMARY

Provided are methods and devices for reducing the processing bittage inside the sensor by preferentially compressing portions of an image which relate to shot noise, in order to reduce processing and storage requirements.

Also provided are methods and devices for extracting and manipulating autofocus data which manifests more detail in low light or saturated areas considering scene details and capture parameters such as exposure, gain, etc.

Additional aspects will be set forth in part in the description which follows and, in part, will be apparent from the description, or may be learned by practice of the presented embodiments.

In accordance with an aspect of the disclosure, a method for performing dynamic range image processing includes: obtaining a plurality of first images which were captured using an image sensor; merging the plurality of first images to obtain a second image, wherein a dynamic range of the second image is higher than a dynamic range of each of the plurality of first images; compressing the second image using a compression function to obtain a compressed second image; performing image processing on the compressed second image to obtain a processed image; and obtaining an output image by decompressing the processed image using a transposition of the compression function, wherein the compression function is divided into a plurality of segments, and wherein a compression power for each segment of the plurality of segments is determined based on a noise profile of the image sensor.

In accordance with an aspect of the disclosure, a device for performing dynamic range image processing includes: an image sensor configured to capture a plurality of first images; and an image signal processor included in the image sensor, wherein the image signal processor is configured to: obtain the plurality of first images; merge the plurality of first images to obtain a second image, wherein a dynamic range of the second image is higher than a dynamic range of each of the plurality of first images; compress the second image using a compression function to obtain a compressed second image; perform image processing on the compressed second image to obtain a processed image; and decompress the processed image using a transposition of the compression function to obtain an output image, wherein the compression function is divided into a plurality of segments, and wherein a compression power for each segment of the plurality of segments is determined based on a noise profile of the image sensor.

In accordance with an aspect of the disclosure, a non-transitory computer-readable medium is configured to store instructions which, when executed by a device for performing dynamic range image processing, cause the device to: obtain a plurality of first images using an image sensor; merge the plurality of first images to obtain a second image, wherein a dynamic range of the second image is higher than a dynamic range of each of the plurality of first images; compress the second image using a compression function to obtain a compressed second image; perform image processing on the compressed second image to obtain a processed image; and decompress the processed image using a transposition of the compression function to obtain an output image, wherein the compression function is divided into a plurality of segments, and wherein a compression power for each segment of the plurality of segments is determined based on a noise profile of the image sensor.

In accordance with an aspect of the disclosure, a method for performing dynamic range image processing includes: obtaining a plurality of first images which were captured using an image sensor; performing exposure level alignment on two first images from among the plurality of first images to obtain a first aligned image and a second aligned image; splitting the first aligned image into a first phase image corresponding to a first phase and a second phase image corresponding to a second phase; splitting the second aligned image into a third phase image corresponding to the first phase and a fourth phase image corresponding to the second phase; merging the first phase image and the second phase image to obtain a first merged image corresponding to the first phase; merging the second phase image and the fourth phase image to obtain a second merged image corresponding to the second phase; and obtaining autofocus information based on the first merged image and the second merged image.

### BRIEF DESCRIPTION OF DRAWINGS

The above and other aspects, features, and advantages of certain embodiments of the present disclosure will be more apparent from the following detailed description taken in conjunction with the accompanying drawings in which:

FIG. 1 is a block diagram illustrating an image processing system according to an embodiment;

FIG. 2 is a block diagram illustrating a structure of an image sensor according to an embodiment;

FIG. 3 is a block diagram illustrating a structure of an HDR processing module, according to an embodiment;

FIG. 4 is a diagram illustrating an HDR processing workflow, according to an embodiment;

FIG. 5A is a diagram illustrating an example of an image sensor noise profile, according to an embodiment;

FIG. 5B is a diagram illustrating an example of a compression function profile, according to an embodiment;

FIG. 6A is a block diagram illustrating a structure of an image processing module, according to an embodiment;

FIG. 6B is a flowchart illustrating an example of a process for performing image processing, according to embodiments

FIG. 7A is a block diagram illustrating a structure of an autofocus processing module, according to an embodiment; and

FIG. 7B is a flowchart illustrating an example of a process for performing image processing, according to embodiments.

### DETAILED DESCRIPTION

Hereinafter, embodiments will be described in detail with reference to the accompanying drawings. Like reference numerals in the drawings denote like elements, and redundant or duplicative description thereof may be omitted.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The term “circuit” used herein may refer to software, or a hardware component such as an FPGA or an ASIC, and “circuit” performs certain roles. However, “circuit” is not limited to software or hardware. The “circuit” may be configured to be on a storage medium that may be addressed, or may be configured to play back one or more processors. Therefore, as an example, “circuit” may include components, such as software components, object-oriented software components, class components, and task components, processes, functions, attributes, procedures, subroutines, segments of program code, drivers, firmware, microcode, circuits, data, databases, data structures, tables, arrays, and variables.

As discussed above, dynamic range (DR) is an important feature of imagers and image sensors, for example complementary metal-oxide-semiconductor (CMOS) imagers and image sensors. The DR of an image may refer to range of luminosity between the brightest area and the darkest area of an image. A high DR (HDR) image may refer to an image which includes a large amount of variation in luminosity levels.

A relatively large number of bits may be used to express the full DR of the HDR image, and this increased bittage may result in increased processing and memory requirements for the on-sensor processing and output. In addition, HDR images may increase the amount of autofocus (AF) data which may be captured and processed in order to increase detail in low light or saturated areas for improved auto-focus procedure.

A significant portion of the DR of an image may represent noise, for example in portions of the image which correspond to relatively high illumination. This means that the actual information content of the image may be compressed to a significantly lower DR but in a non-linear way. This compression alone may be incompatible with standard sensor output, which is generally required to be linear.

Accordingly, embodiments may provide methods and devices for compressing HDR images in a non-linear manner to reduce processing and storage requirements for image processing, and then decompressing the processed image to obtain an output image in a proper (e.g., linear) format.

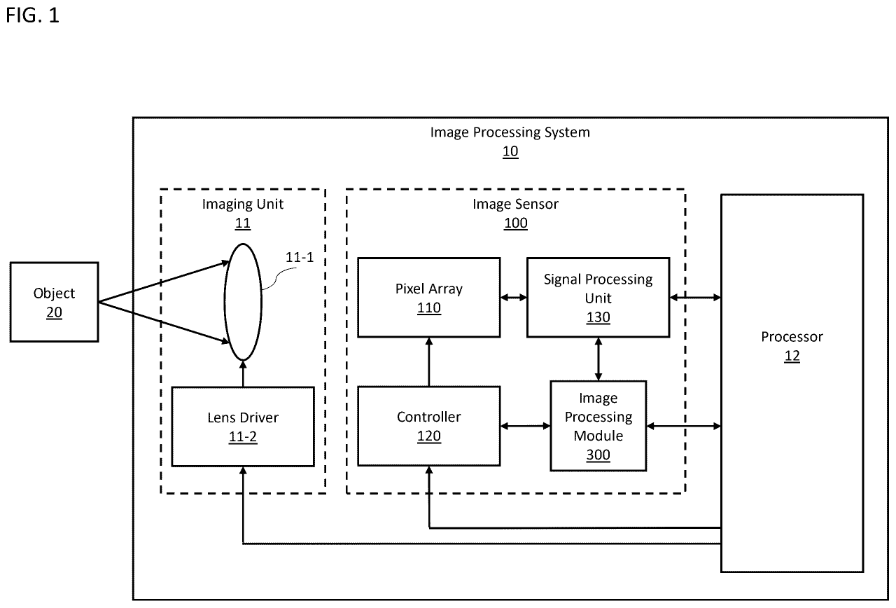

FIG. 1 is a block diagram illustrating an image processing system 10 according to an embodiment. As shown in FIG. 1, the image processing system 10 may include an imaging unit 11, an image sensor 100, and a processor 12. The image processing system 10 may include a focus detection function. In embodiments, the image sensor 100 and the imaging unit 11 may be components included in a camera module, but embodiments are not limited thereto.

The image processing system 10 may be implemented as an electronic device that captures an image and displays the captured image or performs an operation based on the captured image. The image processing system 10 may be, or may include, for example, at least one of a personal computer (PC), an Internet of Things (IoT) device, and a portable electronic device. The portable electronic device may include at least one of a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an electronic book (e-book), a wearable device, and the like. In addition, the image processing system 10 may be mounted on an electronic device, such as a drone, an advanced drivers assistance system (ADAS), a robotic device such as a vacuum cleaner, or an electronic device provided as a component in a vehicle, such as for example an in-cabin or reverse camera, or in furniture, manufacturing equipment, a door, various types of measurement devices or the like.

The image processing system 10 may further include other components, such as a display and a user interface. The image processing system 10 may be implemented as a system on chip (SoC). Although FIG. 1 illustrates the imaging unit 11, the image sensor 100, the processor 12, and all of the components included therein as being included in a single image processing system 10, embodiments are not limited thereto. For example, in some embodiments one or more of the imaging unit 11, the image sensor 100, the processor 12 may be included in different systems and/or different devices, and one or more of the components illustrated as being included therein, for example one or more of the pixel array 110, the controller 120, the signal processing unit 130, and the image processing module 130, may be included in different systems and/or different devices.

The overall operation of the image processing system 10 may be controlled by the processor 12. The processor 12 may provide a lens driver 11-2, a controller 120, and the like with a control signal for an operation of each component. For example, the imaging unit 11 may further include an aperture driver for driving an aperture, or for example a driver for driving an optical image stabilization (OIS) or electronic image stabilization (EIS) system, and the processor 12 may provide a control signal for controlling the aperture driver. In an embodiment, the processor 12 may be an application processor (AP).

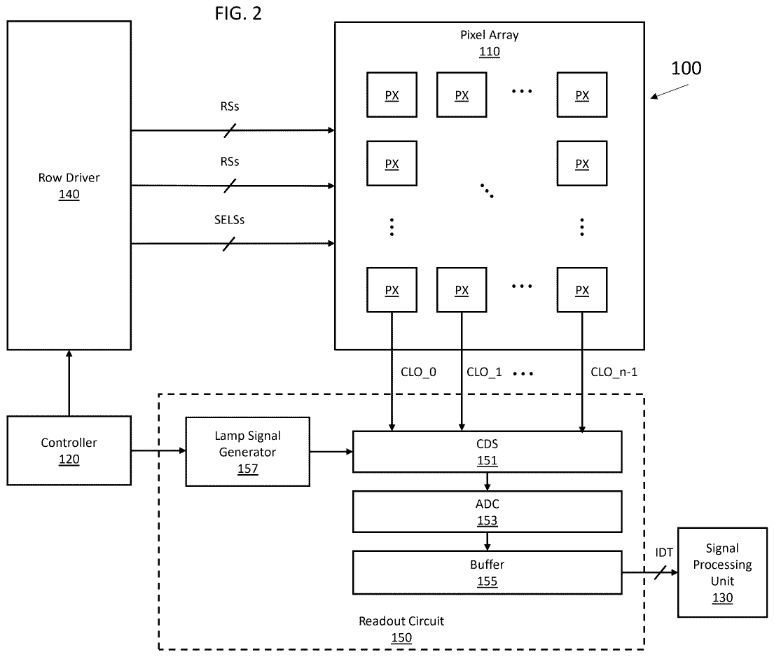

The imaging unit 11 may be a component for receiving light, and may include an optical lens 11-1 and the lens driver 11-2. The optical lens 11-1 may include a plurality of lenses. The image sensor 100 may convert, into an electrical signal, a light signal reflected from an object 20 through the optical lens 11-1, and may generate image data, for example image data IDT as shown in FIG. 2, on the basis of electrical signals. Although FIG. 1 illustrates the optical lens 11-1 as including one lens, embodiments are not limited thereto. For example, the optical lens 11-1 may also include a plurality of lenses.

The lens driver 11-2 may communicate information regarding focus detection with the processor 12, and may adjust a position and/or an angle of the optical lens 11-1 according to a control signal provided by the processor 12. The lens driver 11-2 may move the optical lens 11-1 in a direction in which a distance from the object 20 increases or decreases, and accordingly, a distance between the optical lens 11-1 and the object 20 may be adjusted. A focus on the object 20 may be adjusted, which may cause an image of the object 20 to be focused or blurred, according to the position of the optical lens 11-1. According to embodiments, operations performed to adjust the focus may be referred to as AF operations.

The image sensor 100 may convert incident light into an image signal. The image sensor 100 may include a pixel array 110, a controller 120, and a signal processing unit 130. An optical signal transmitted through the optical lens 11-1 may reach a light receiving surface of the pixel array 110 and form an image of the object 20. According to embodiments, an analog dark noise of the image sensor 100 may be similar in size to a quantization noise (e.g., up to about one order of magnitude), but embodiments are not limited thereto. According to embodiments, a DR of the image sensor 100 may be sufficiently high such that shot noise in high illumination of the image is larger than one bit, but embodiments are not limited thereto.

The pixel array 110 may be a complementary metal-oxide-semiconductor (CMOS) image sensor (CIS) that converts an optical signal into an electrical signal. However, embodiments are not limited thereto, and in some embodiments, the pixel array may include any type of image-capturing sensor. The sensitivity of the pixel array 110, and/or other parameters of the pixel array 110, may be adjusted by the controller 120. The pixel array 110 may include a plurality of pixels that convert an optical signal into an electrical signal. Each of the plurality of pixels may generate a pixel signal according to a sensed intensity of light.

The image processing module 300 may be used to generate and process HDR images, and to perform other image processing tasks. Examples of the image processing module 300 are discussed in greater detail below. According to embodiments, the image processing module 300 may be an application specific integrated circuit (ASIC), but embodiments are not limited thereto. The image processing module 300 may be referred to as an image signal processor (ISP). In some embodiments, the image processing module 300 may be included in the image sensor 100, but embodiments are not limited thereto. For example, in some embodiments the image processing module 300 may be included in any other component of the image processing system 10, for example at least one of the processor 12 and the signal processing unit 130, or may be included in the image processing system 10 separately from the other components.

The processor 12 may reduce noise with respect to input data, and may perform, on the input image, imaging signal processing for image quality improvement, such as gamma correction, color filter array interpolation, color matrix, color correction, and color enhancement. In addition, the processor 12 may generate an image file by compressing image data generated by performing image signal processing for image quality improvement, or may restore image data from the image file.

The pixel array 110 may include a color filter array including color filters configured to allow sensing of various colors, and each of the plurality of pixels may sense a corresponding color. Accordingly, the image sensor 100 may generate output image data including color information. The processor 12 may perform an operation of converting a format of the output image data into full color image data having each of a red color, a green color, and a blue color. In embodiments, the color filter array may have a pattern, which may allow the image sensor 100 to generate output image data having a particular pattern. For example, the color filter array and the output image data may correspond to a pattern such as a Bayer pattern and an N×N Bayer pattern, where N is a natural number greater than one (“1”), but embodiments are not limited thereto.

FIG. 2 is a block diagram illustrating a structure of an image sensor according to an embodiment. Referring to FIG. 2, an image sensor 100 may include a pixel array 110, a controller 120, a signal processing unit 130, a row driver 140, and a readout circuit 150. The readout circuit 150 may include correlated double sampling (CDS) unit 151, an analog-to-digital converter (ADC) 153, and a buffer 155.

The pixel array 110 may convert an optical signal into an electrical signal, and may include a plurality of pixels PX that are two-dimensionally arranged. The plurality of pixels PX may respectively generate pixel signals according to a sensed intensity of light. Each pixel PX may be implemented as, for example, a photoelectric conversion device, such as a charge coupled device (CCD) or CMOS, and may be implemented as various types of photoelectric conversion devices. The pixel array 110 may include a color filter array configured to allow sensing of various colors, and each of the plurality of pixels PX may sense a corresponding color.

The plurality of pixels PX may respectively output pixel signals to the CDS unit 151 through corresponding first to n^{th} column output lines CLO_0 to CLO_n−1. The CDS unit 151 may sample and hold a pixel signal provided from the pixel array 110. The CDS unit 151 may double-sample, or more than double-sample, a level of particular noise (which may be referred to as a reset level), and a level according to an image signal (which may be referred to as an image level), and may output a level corresponding to a difference thereof. In addition, the CDS unit 151 may receive a lamp signal generated by a lamp signal generator 157, and may output a comparison result by comparing the lamp signal with the pixel signal.

The ADC 153 may convert an analog signal corresponding to a level received from the CDS unit 151 into a digital signal. The buffer 155 may latch a digital signal, and the latched digital signal may be sequentially output as image data IDT to the outside of the signal processing unit 130 or the image sensor 100. In embodiments, the output image data IDT may have a pattern corresponding to pattern of the CFA. For example, based on the CFA having a Bayer pattern, the image data IDT may be Bayer pattern image data corresponding to the Bayer pattern, but embodiments are not limited thereto.

The controller 120 may control the row driver 140 so that the pixel array 110 absorbs light to accumulate electric charges, temporarily stores the accumulated electric charges, and outputs an electrical signal according to the stored electric charges to the outside of the pixel array 110. In addition, the controller 120 may control the readout circuit 150 to measure a level of a pixel signal provided by the pixel array 110.

The row driver 140 may generate signals (e.g., reset control signals RSs, transmission control signals TSs, and selection signals SELSs) for controlling the pixel array 110 and provide the signals (e.g., the reset control signals RSs, the transmission control signals TSs, and the selection signals SELSs) to the plurality of pixels PX. The row driver 140 may determine activation and deactivation timings of the reset control signals RSs, the transmission control signals TSs, and the selection signals SELSs provided to the pixels PX.

The signal processing unit 130 may perform signal processing on the received image data IDT output from the readout circuit 150. For example, based on the image data IDT being Bayer pattern image data, the signal processing unit 130 may perform a demosaicing operation on the Bayer pattern image data to generate output image data having a different pattern, for example red-green-blue (RGB) image data having an RGB pattern. In embodiments, demosaicing operation may refer to an operation of interpolating image data having a CFA pattern, such as the Bayer pattern image data, into a full color image, and the RGB image data may be image data of the full color image, in which each pixel of the RGB image data contains information of the red, green and blue colors. However, embodiments are not limited thereto, and for example in some embodiments the CFA may have a pattern other than a Bayer pattern, and/or may have color filters other than RGB color filters (e.g., white, infrared, cyan-magenta-yellow (CMY), etc.).

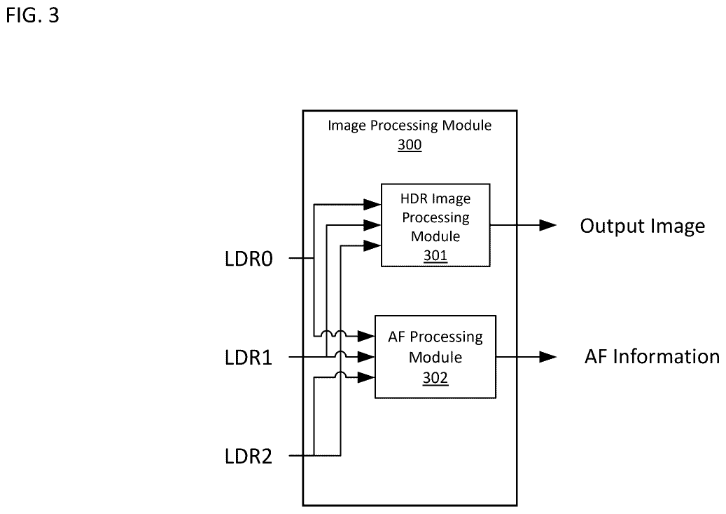

FIG. 3 is a block diagram illustrating a structure of an HDR processing module, according to an embodiment. As shown in FIG. 3, the image processing module 300 may include an HDR image processing module 301 and an AF processing module 302, but embodiments are not limited thereto.

According to embodiments, the DR of an image may be constrained or otherwise determined by a DR capability of the image sensor used to capture the image (e.g., the image sensor 100), which may be determined by a highest and lowest illumination level which the image sensor is capable of detecting. However, because HDR images may be visually appealing and therefore desired by users, it may be desirable to generate HDR images using multiple images with relatively lower DR, which may be referred to as low DR (LDR) images. One such approach is multi-exposure HDR capture, which may involve obtaining a plurality of LDR images at different exposure levels, and combining the plurality of LDR images to obtain an HDR image. However, embodiments are not limited thereto, and in some embodiments the LDR images may be captured using different conversion gains, different analog gains, different multi-sampling, etc.

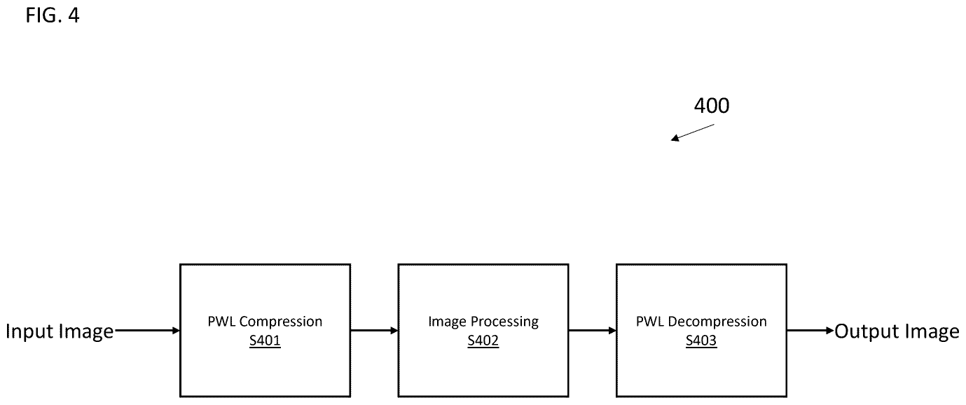

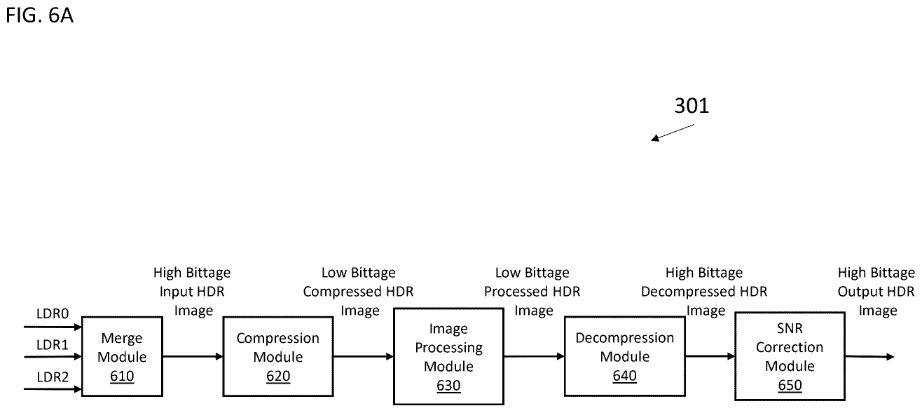

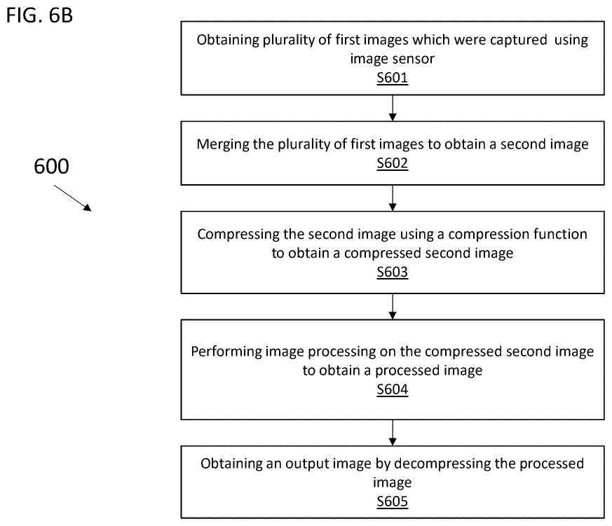

According to embodiments, the image processing system 10 may capture a plurality of LDR images, for example a first LDR image LDR0, a second LDR image LDR1, and a third LDR image LDR2, and may provide the plurality of LDR images to the image processing module 300 to generate an output image such as an HDR image. According to embodiments, the plurality of LDR images may be provided to the HDR image processing module 301 and the AF processing module 302 to be processed in parallel. However, embodiments are not limited thereto, and in some embodiments, the AF processing module 302 may receive a different set of data than the HDR image processing module 301, for example a different set of LDR images, or a sub-set of LDR images. According to embodiments, the HDR image processing module 301 may receive the plurality of LDR images as input, and may use the plurality of LDR images to generate an output image, which may be for example an HDR image. In some embodiments, the HDR image processing module 301 may merge the plurality of LDR images to obtain an input HDR image, and may compress the HDR input image before performing image processing in order to reduce processing and memory requirements, but embodiments are not limited thereto. Examples of the structure and operation of the HDR image processing module 301 are described below with reference to FIG. 4 and FIGS. 6A-6B.

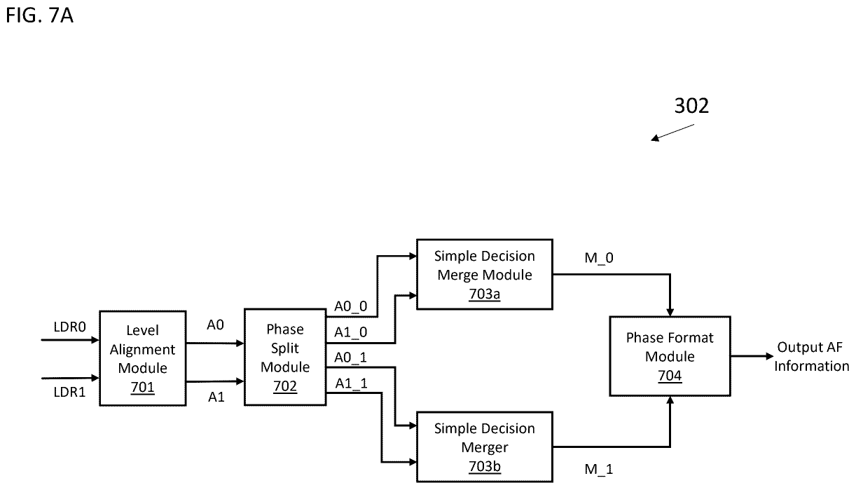

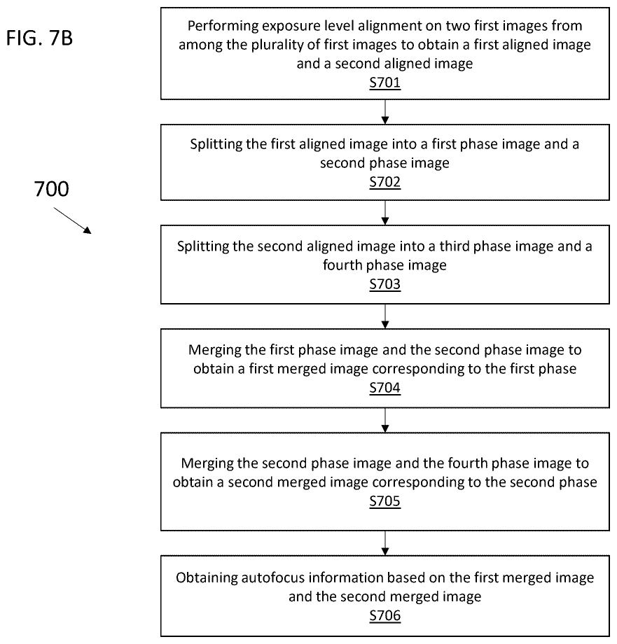

According to embodiments, the AF processing module 302 may be configured to process images having different phases to provide information that may be used to perform phase-detection autofocusing (PDAF) operations. However, embodiments are not limited thereto, and in general any AF operation may gain value from operating on an HDR image rather than an LDR image. Accordingly, the AF processing module 302 is not limited to PDAF, and may operate based on contrast-based AF, or any other AF technique. In embodiments, the output of the AF processing module 302 may be used by the processor 12 or any other component of the image processing system 10 to control the lens driver 11-2 to move the lens 11 to adjust focus. The output of the AF processing module 302 may be an image that contains data that represents different phases at each pixel position, but embodiments are not limited thereto. For example, in some embodiments the output of the AF processing module may also be a signal (e.g., statistics, or an AF decision) instead of an image. Examples of the structure and operation of the AF processing module 302 are described below with reference to FIGS. 7A-7B.

Although embodiments are described herein in which the image processing module 300 receives three LDR images as input images, and provides an HDR image as an output image, embodiments are not limited thereto. For example, the image processing module may receive any number of LDR images or HDR images as input images or output images.

FIG. 4 is a diagram illustrating an HDR processing workflow, according to an embodiment. In embodiments, the process 400 illustrated in FIG. 4 may be performed by the HDR image processing module 301, but embodiments are not limited thereto.

According to embodiments, the plurality of LDR images may have a natural shot noise profile that may be measured and reliably predicted. In some embodiments, the shot noise profile of the LDR images may be, or may correspond to, a noise profile of the image sensor (e.g., the image sensor 100) used to capture the LDR images, but embodiments are not limited thereto.

As discussed above, a significant share of the DR of an image may represent noise, especially in portions of the image corresponding to high illumination. This means that the actual information content of the image may be compressed to a significantly lower DR but in a non-linear way. For example, a compression power of the compression function may vary non-linearly, such that portions of the image corresponding to relatively higher noise are compressed more than portions of the image corresponding to relatively lower noise. This compression alone may be incompatible with standard sensor output, which may generally be required to be linear. Accordingly, the HDR image processing module 301 may compress an input image before performing image processing. In some embodiments, the image to be compressed and processed may be an HDR image, which may be for example generated based on a plurality of LDR images, but embodiments are not limited thereto

For example, as shown in FIG. 4, a process 400 for performing image processing may include compressing the input image at operation S401 before performing image processing (e.g., on-sensor image processing) at operation S402. In embodiments, the image processing may include, for example, bad pixel correction (BPC), noise reduction (NR), or any other type of image processing. After the processing is complete, the processed image may be decompressed back to the linear domain at operation S403 to obtain an output image. As a result, the image processing may be performed using a lower bittage (e.g., fewer bits) than would be used to process the uncompressed input image, which may reduce processing and memory requirements corresponding to the image processing.

In embodiments, the image to be compressed and processed may be an HDR image, which may be generated based on a plurality of LDR images, but embodiments are not limited thereto. For example, in some embodiments the image to be compressed and processed may be a non-HDR image, or may be an HDR image generated in another manner, as long as the input image is linear.

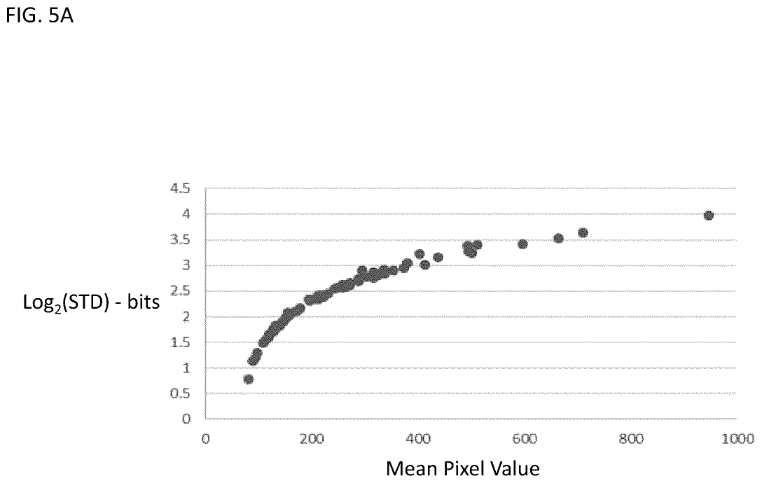

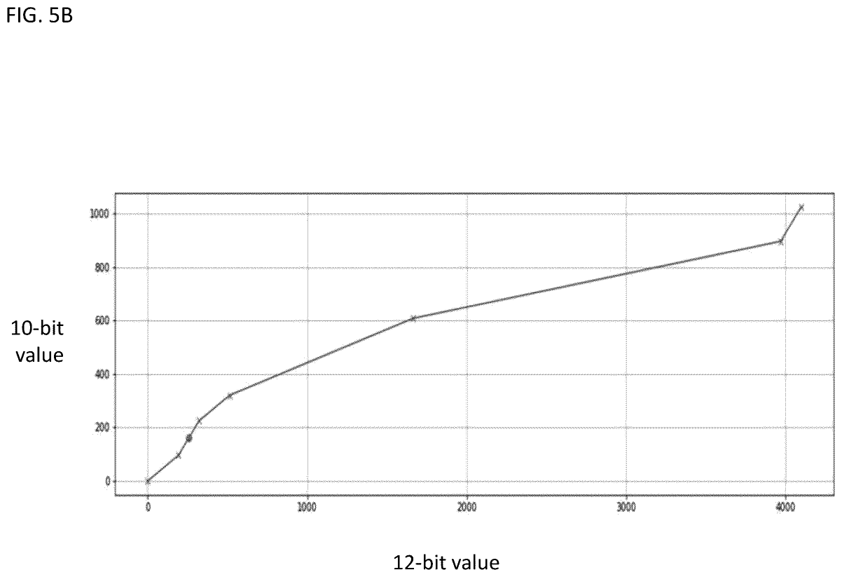

FIG. 5A is a diagram illustrating an example of an image sensor noise profile, according to an embodiment. FIG. 5B is a diagram illustrating an example of a compression function profile, according to an embodiment.

To apply the compression discussed above, embodiments may use a pair of mapping functions, which may be for example a pair of piecewise linear (PWL) mapping functions, that correspond to the predicted/measured noise model of the image as a compression and decompression functions. For example, as shown in FIG. 5A, a noise profile of an image sensor (e.g., the image sensor 100) may have a particular shape. Therefore, as shown in FIG. 5B a PWL mapping function having a shape that corresponds to the shape of the noise profile may be selected to be used as a compression function (e.g., a PWL compression function). In embodiments, the PWL mapping function may be determined to have the shape corresponding to the shape of the noise profile based on having overall proportions or ratios which are similar to the shape of the noise profile. According to embodiments, the PWL mapping function shown in FIG. 5B may be used as the compression function to compress the HDR image before image processing, and a transposition of this PWL mapping function may be used as a decompression function (e.g., a PWL decompression function) to decompress the processed HDR image to obtain the output image. Although examples are described herein which relate to PWL mapping, embodiments are not limited thereto. For example, in some embodiments the mapping functions may be implemented using other types of mapping, for example complete value mapping.

The compression function may be used to map an input of a particular DR to an output of a different DR (either higher or lower) by reducing a different number of least significant bits (LSBs) used to represent image data in each linear segment. For example, the PWL compression function shown in FIG. 5B may be used to map 12-bit pixel values to corresponding 10-bit pixel values. As a result, the PWL compression function shown in FIG. 5B may be used to map an input image expressed using twelve bits to a compressed image that may be expressed using ten bits (e.g., approximately 20% reduction). Accordingly, a size of a processing hardware used by the HDR image processing module 301 may be reduced by a corresponding number of bits.

According to embodiments, the compression function may have a relatively simple implementation, which may result in relatively small or efficient compression hardware. For example, in some embodiments (e.g., in the PWL compression function shown in FIG. 5B) the slope of each linear segment (which may correspond to the compression power of each linear segment) may be set to an integer power of two (“2”), which may translate directly to the number of bits reduced in each segment. Accordingly, the compression function may be implemented using bit shift operations which may be performed using relatively simple bit shift registers, but embodiments are not limited thereto. According to embodiments, the compression function may be used to compress and decompress the images without losing any image quality (e.g., such that the input image and output image are indistinguishable and/or have the same noise properties) but embodiments are not limited thereto.

According to embodiments, decompression function may be a transposed image of the compression function in order to maintain linearity in the signal strength at the sensor output. In some embodiments, if the decompression function includes slopes that are larger than one, zero-mean dithering may be applied to result in a natural output histogram.

FIG. 6A is a block diagram illustrating a structure of an HDR image processing module, according to an embodiment. As shown in FIG. 6A, the HDR image processing module 301 may include a merge module 610, a compression module 620, an image processing module 630, a decompression module 640, and a signal-to-noise (SNR) correction module 650.

According to embodiments, the merge module 610 may receive the plurality of LDR images (e.g., the first LDR image LDR0, the second LDR image LDR1, and the third LDR image LDR2), and may merge the plurality of LDR images to obtain an input HDR image. The compression module 620 may compress the input HDR image to obtain a compressed HDR image. In some embodiments, the compression module 620 may use the PWL compression function discussed above, but embodiments are not limited thereto. The image processing module 630 may perform image processing on the compressed HDR image to obtain a processed HDR image. In some embodiments, the image processing operations may include, for example, BPC, NR, etc. The decompression module 640 may decompress the processed HDR image to obtain a decompressed HDR image. The SNR correction module 650 may perform SNR correction, for example to mitigate an SNR dip that may be produced by the HDR merging performed by the merge module 610. Accordingly, the HDR image processing module 301 may produce an output HDR image.

In embodiments, the input HDR image, the decompressed HDR image, and the output HDR image may be high-bittage images, which may mean that they are expressed using a relatively large number of bits. In addition, the compressed HDR image and the processed HDR image may be low-bittage images, which may mean that they are expressed using a relatively small number of bits (e.g., fewer bits than the high-bittage images). Accordingly, a size, complexity, and energy usage of the image processing module 630 may be reduced.

FIG. 6B is a flowchart illustrating an example of a process for performing DR image processing, according to an embodiment. In some implementations, one or more process blocks of FIG. 6B may be performed by any of the elements discussed above, for example one or more of the image processing system 10 and any component included therein, such as the image processing module 300 and the HDR image processing module 301, but embodiments are not limited thereto.

As shown in FIG. 6B, at operation S601 the process 600 may include obtaining a plurality of first images which were captured using an image sensor. In embodiments, the plurality of first images may correspond to the plurality of LDR images (e.g., the first LDR image LDR0, the second LDR image LDR1, and the third LDR image LDR2) discussed above.

As further shown in FIG. 6B, at operation S602 the process 600 may include merging the plurality of first images to obtain a second image, wherein a dynamic range of the second image is higher than a dynamic range of each of the plurality of first images. In embodiments, the second image may correspond to the input HDR image discussed above.

As further shown in FIG. 6B, at operation S603 the process 600 may include compressing the second image using a compression function to obtain a compressed second image. In embodiments, the compression function may be divided into a plurality of segments, and a compression power for each segment of the plurality of segments is determined based on a noise profile of the image sensor. In embodiments, the compression function may correspond to the PWL compression function discussed above. In embodiments, the compressed second image may correspond to the compressed HDR image discussed above.

As further shown in FIG. 6B, at operation S604 the process 600 may include performing image processing on the compressed second image to obtain a processed image. In embodiments, the processed image may correspond to the processed HDR image discussed above.

As further shown in FIG. 6B, at operation S605 the process 600 may include obtaining an output image by decompressing the processed image using a transposition of the compression function. In embodiments, operation S605 may further include obtaining a decompressed image by decompressing the processed image using the transposition of the compression function, and performing signal-to-noise (SNR) correction on the decompressed image to obtain the output image. In embodiments, the decompressed image may correspond to the decompressed HDR image discussed above, and the output image may correspond to the output HDR image discussed above.

In embodiments, a first compression power associated with a first segment from among the plurality of segments may be different from a second compression power associated with a second segment from among the plurality of segments, and the first compression power and the second compression power may be determined based on the noise profile of the image sensor.

In embodiments, the second image and the output image may correspond to a first bit length, wherein the compressed second image and the processed image may correspond to a second bit length, and the second bit length may be less than the first bit length.

In embodiments, a compression function may include a PWL function including the plurality of segments, and each segment from among the plurality of segments may be linear.

In embodiments, the plurality of segments may be associated with a plurality of slopes, wherein each slope from among the plurality of slopes is an integer power of two (“2”).

In embodiments, the compressing may be performed using a plurality of bit shift operations corresponding to the plurality of slopes.

In embodiments, the obtaining the output image may further include obtaining a decompressed image by decompressing the processed image using the transposition of the compression function; and performing signal-to-noise (SNR) correction on the decompressed image to obtain the output image.

FIG. 7A is a block diagram illustrating a structure of an autofocus processing module, according to an embodiment. As shown in FIG. 7, the AF processing module 302 may include a level alignment module 701, a phase split module 702, a first simple decision merge module 703a, a second simple decision merge module 703b, and a phase format module 704. However, embodiments are not limited thereto. For example, in some embodiments the AF processing module 302 may have additional simple decision merge models, depending on the number of LDR images which may be used.

According to embodiments, in order to capture the plurality of LDR images with multiple exposures for both image processing and AF processing, the LDR images may be captured in difficult conditions (e.g., relatively very low or very high exposures equivalent). Accordingly, it may be beneficial to merge the data from the plurality of LDR images to obtain reasonable data for performing AF operations. According to embodiments, the same LDR images may be used for both image processing and AF processing, but embodiments are not limited thereto. For example, in some embodiments the AF processing may be performed on a subset of the plurality of LDR images used for the image processing, or on different LDR images.

Because of the potential disparity in exposures and/or gains of the plurality of LDR images, the level alignment module 701 may be used to align the exposure levels of the plurality of LDR images, in order to obtain a plurality of aligned images (e.g., a first aligned image A0 and second aligned image A1). A leveling ratio to be applied to the one or more of the plurality of LDR images may be determined according to Equation 1 below, in which AF_{LDR0} denotes the exposure level of the first LDR image LDR0, AF_{LDR1} denotes the exposure level of the second LDR image LDR1, and ratio denotes the leveling ratio.

$${AF}_{LDR 0} = ratio * {AF}_{LDR 1} \qquad Equation 1$$

Because the pattern of the different phases may change upon merging, the images may be split into multiple images corresponding to different phases before being merged. For example, the phase split module 702 may split the first aligned image A0 into a first phase image A0_0 corresponding to a first phase and a second phase image A0_1 corresponding to a second phase. Similarly, the phase split module 702 may split the second aligned image A1 into a third phase image A1_0 corresponding to the first phase and a fourth phase image A1_1 corresponding to the second phase. In addition, in some embodiments, the LDR images may differ by some other parameter, for example conversion gain, analog gain, multi-sampling, or a combination of any of these parameters, and the leveling ratio of Equation 1 may correspond to the appropriate parameter or parameters.

Because these images are only being used for AF processing, they can be merged without consideration for visual appeal. Accordingly, the first simple decision merge module 703a and the second simple decision merge module 703b may use a relatively simple decision procedure, for example as illustrated in Equation 2 below, in which P_{A0} denotes a pixel value of phase image corresponding to the first aligned image A0 (e.g., a pixel value from the first phase image A0_0 and the second phase image A0_1), P_{A1} denotes a pixel value of a phase image corresponding to the second aligned image A1 (e.g., a pixel value from the third phase image A1_0 or the fourth phase image A1_1), and SAT denotes a threshold pixel value (which may, for example, correspond to a saturation level of the image sensor).

$${P}_{A 0} > SAT \to use {P}_{A 1} ; else \to use {P}_{A 0}$$

The first simple decision merge module 703a may generate the first merged image M_0, and the second simple decision merge module 703b may generate the second merged image M_1. In embodiments, a dynamic range of the first merged image M_0 and a dynamic range of the second merged image M_1 may be higher than a dynamic range of each of the plurality of LDR images (e.g., the first merged image M_0 and the second merged image M_1 may be HDR images). These images may be provided to the phase format module 704, which may generate output AF information which may be used to perform AF operations. In embodiments, the output AF information may be or may include an image that contains data that represents different phases at each pixel position, or a signal (e.g., statistics, or an AF decision) which may be used to perform the AF operations.

Although examples are described herein in which two LDR images and two phases are used, embodiments are not limited thereto. For example, according to embodiments the AF processing module 302 may receive x LDR images each containing the information of y different phases (e.g., two phases or four phases). Each LDR image may be provided to the phase split module 702 and may be split into y different LDR images, each representing a single phase, to obtain x*y images, each containing an LDR image of a single phase. Then all of the LDR images corresponding to each phase may be input into a corresponding simple decision merge module, which may merge them to a single HDR image for each phase. Next, all of the HDR images corresponding to the different phases may be input into the phase format module 704, which may combine them to a single AF output.

In embodiments, HDR images may be used as the input images to even further improve the amount of details in the output AF information, and/or to mitigate possible motion artifacts. In addition, the number of LDR images illustrated in FIG. 7A and described above is an example, and embodiments are not limited thereto.

FIG. 7B is a flowchart illustrating an example of a process for performing DR image processing, according to embodiments. In some implementations, one or more process blocks of FIG. 7B may be performed by any of the elements discussed above, for example one or more of the image processing system 10 and any component included therein, such as the image processing module 300 and the AF processing module 302, but embodiments are not limited thereto.

As shown in FIG. 7B, at operation S701 the process 700 may include performing exposure level alignment on two first images from among the plurality of first images to obtain a first aligned image and a second aligned image. In embodiments, the first aligned image may correspond to the first aligned image A0, and the second aligned image may correspond to the second aligned image A1.

As further shown in FIG. 7B, at operation S702 the process 700 may include splitting the first aligned image into a first phase image corresponding to a first phase and a second phase image corresponding to a second phase. In embodiments, the first phase image may correspond to the first phase image A0_0, and the second phase image may correspond to the second phase image A0_1.

As further shown in FIG. 7B, at operation S703 the process 700 may include splitting the second aligned image into a third phase image corresponding to the first phase and a fourth phase image corresponding to the second phase. In embodiments, the third phase image may correspond to the third phase image A1_0, and the fourth phase image may correspond to the fourth phase image A1_1. As discussed above, embodiments are not limited to only two phases, and in some embodiments a different number of phases may be used. For example, if four phases are used, then each of the four phases may use a corresponding merge module and merge functions, each of which may receive the appropriate number of LDR images.

As further shown in FIG. 7B, at operation S704 the process 700 may include Merging the first phase image and the second phase image to obtain a first merged image corresponding to the first phase. In embodiments, the first merged image may correspond to the first merged image M_0.

As further shown in FIG. 7B, at operation S705 the process 700 may include merging the third phase image and the fourth phase image to obtain a second merged image corresponding to the second phase. In embodiments, the second merged image may correspond to the second merged image M_1.

As further shown in FIG. 7B, at operation S706 the process 700 may include splitting the second aligned image into a third phase image corresponding to the first phase and a fourth phase image corresponding to the second phase.

Accordingly, embodiments of the present disclosure may have several benefits compared to other approaches. For example, embodiments may allow processing and memory hardware included in the HDR image processing module 301 (e.g., on-sensor processing and memory hardware) to be reduced in size by approximately the number of reduced bits. In addition, the AF processing module 302 may take advantage of the plurality of LDR images to allow higher AF performance due to providing more details in low light or saturated areas in comparison to relying on a single LDR image. As a result of these benefits, embodiments may be particularly well-suited for performing DR image processing.

The various operations of methods described above may be performed by any suitable elements capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. A method for performing dynamic range image processing, the method comprising:
obtaining a plurality of first images which were captured using an image sensor;
merging the plurality of first images to obtain a second image, wherein a dynamic range of the second image is higher than a dynamic range of each of the plurality of first images;
compressing the second image using a compression function to obtain a compressed second image;
performing image processing on the compressed second image to obtain a processed image; and
obtaining an output image by decompressing the processed image using a transposition of the compression function,
wherein the compression function is divided into a plurality of segments, and
wherein a compression power for each segment of the plurality of segments is determined based on a noise profile of the image sensor.

2. The method of claim 1, wherein a first compression power associated with a first segment from among the plurality of segments is different from a second compression power associated with a second segment from among the plurality of segments, and
wherein the first compression power and the second compression power are determined based on the noise profile of the image sensor.

3. The method of claim 1, wherein the second image and the output image correspond to a first bit length,
wherein the compressed second image and the processed image correspond to a second bit length, and
wherein the second bit length is less than the first bit length.

4. The method of claim 1, wherein the compression function comprises a piecewise linear (PWL) function comprising the plurality of segments, and
wherein each segment from among the plurality of segments is linear.

5. The method of claim 4, wherein the plurality of segments are associated with a plurality of slopes,
wherein each slope from among the plurality of slopes is an integer power of two (“2”).

6. The method of claim 5, wherein the compressing is performed using a plurality of bit shift operations corresponding to the plurality of slopes.

7. The method of claim 1, wherein the obtaining the output image further comprises:
obtaining a decompressed image by decompressing the processed image using the transposition of the compression function; and
performing signal-to-noise (SNR) correction on the decompressed image to obtain the output image.

8. The method of claim 1, further comprising:
performing an autofocus operation based on the plurality of first images.

9. The method of claim 8, wherein the autofocus operation comprises:
performing exposure level alignment on two first images from among the plurality of first images to obtain a first aligned image and a second aligned image;
splitting the first aligned image into a first phase image corresponding to a first phase and a second phase image corresponding to a second phase;
splitting the second aligned image into a third phase image corresponding to the first phase and a fourth phase image corresponding to the second phase;
merging the first phase image and the second phase image to obtain a first merged image corresponding to the first phase;
merging the second phase image and the fourth phase image to obtain a second merged image corresponding to the second phase; and
obtaining autofocus information based on the first merged image and the second merged image.

10. A device for performing dynamic range image processing, the device comprising:
an image sensor configured to capture a plurality of first images; and
an image signal processor included in the image sensor, wherein the image signal processor is configured to:
obtain the plurality of first images;
merge the plurality of first images to obtain a second image, wherein a dynamic range of the second image is higher than a dynamic range of each of the plurality of first images;
compress the second image using a compression function to obtain a compressed second image;
perform image processing on the compressed second image to obtain a processed image; and
decompress the processed image using a transposition of the compression function to obtain an output image,
wherein the compression function is divided into a plurality of segments, and
wherein a compression power for each segment of the plurality of segments is determined based on a noise profile of the image sensor.

11. The device of claim 10, wherein a first compression power associated with a first segment from among the plurality of segments is different from a second compression power associated with a second segment from among the plurality of segments, and
wherein the first compression power and the second compression power are determined based on the noise profile of the image sensor.

12. The device of claim 10, wherein the second image and the output image correspond to a first bit length,
wherein the compressed second image and the processed image correspond to a second bit length, and
wherein the second bit length is less than the first bit length.

13. The device of claim 10, wherein the compression function comprises a piecewise linear (PWL) function comprising the plurality of segments, and
wherein each segment from among the plurality of segments is linear.

14. The device of claim 13, wherein the plurality of segments are associated with a plurality of slopes,
wherein each slope from among the plurality of slopes is an integer power of two (“2”).

15. The device of claim 14, wherein the instructions further cause the device to compress the second image using a plurality of bit shift operations corresponding to the plurality of slopes.

16. The device of claim 10, wherein to obtain the output image, the instructions further cause the device to:
obtain a decompressed image by decompressing the processed image using the transposition of the compression function; and
perform signal-to-noise (SNR) correction on the decompressed image to obtain the output image.

17. The device of claim 10, wherein the instructions further cause the device to perform an autofocus operation based on the plurality of first images.

18. The device of claim 17, wherein to perform the autofocus operation, the instructions further cause the device to:
perform exposure level alignment on two first images from among the plurality of first images to obtain a first aligned image and a second aligned image;
split the first aligned image into a first phase image corresponding to a first phase and a second phase image corresponding to a second phase;
split the second aligned image into a third phase image corresponding to the first phase and a fourth phase image corresponding to the second phase;
merge the first phase image and the second phase image to obtain a first merged image corresponding to the first phase;
merge the second phase image and the fourth phase image to obtain a second merged image corresponding to the second phase; and
obtain autofocus information based on the first merged image and the second merged image.

19. A method for performing dynamic range image processing, the method comprising:
obtaining a plurality of first images which were captured using an image sensor;
performing exposure level alignment on two first images from among the plurality of first images to obtain a first aligned image and a second aligned image;
splitting the first aligned image into a first phase image corresponding to a first phase and a second phase image corresponding to a second phase;
splitting the second aligned image into a third phase image corresponding to the first phase and a fourth phase image corresponding to the second phase;
merging the first phase image and the second phase image to obtain a first merged image corresponding to the first phase;
merging the second phase image and the fourth phase image to obtain a second merged image corresponding to the second phase; and
obtaining autofocus information based on the first merged image and the second merged image.

20. The method of claim 19, wherein a dynamic range of the first merged image and a dynamic range of the second merged image are higher than a dynamic range of each of the plurality of first images.
